(19) United States
(12) Patent Application Publication
(10) Pub. No.: US 2006/0062089 A1
(43) Pub. Date: Mar. 23, 2006

(54) Timepiece with LCD schedule function

(76) Inventor: Ronald S. Lizzi, Bethany, CT (US)

Correspondence Address: Athur G. Schaier;Carmody & Torrance LLP, 50 Leavenworth Street, P.O. Box 1110, Waterbury, CT, 06721-1110, US

(21) Appl. No.: 10/944,573

(22) Filed: Sep. 17, 2004

(51) Int. Cl. G04C 17/02; G04C 19/02

(52) U.S. Cl. 368/240

(57) ABSTRACT

An electronic device having a face, the electronic device comprising: a plurality of liquid crystal display segments arranged circumferentially about the face, wherein each of the liquid crystal display segments represents a period of time that is based on the total number of arranged liquid crystal display segments, wherein each of the plurality of liquid crystal display segments are changeable between an inactive state and an active state; activation means for changing selected ones of the liquid crystal display segments between the inactive state and the active state by generating voltages across the selected ones of the liquid crystal display segments; and manual selecting means for selecting one or more of the liquid crystal display segments to change between one of the inactive state and active state to the other of the inactive state or active state.

### BACKGROUND OF THE INVENTION

The present invention is directed generally to multimode electronic devices, such as wristwatches (but not by limitation), and, in particular, to a novel method of and multimode electronic device for indicating periods of time, such as for meetings, appointments, activities, alerts or the like, which are readily viewable on the face of the device. More specifically, the present invention provides a unique construction for displaying information, such as scheduling information, on the face of the device.

Watches typically referred to as “digital” watches have a mode (e.g. “ALARM”) whereby an alarm could be set to remind a user of an upcoming meeting, appointment, activity (e.g. medicine taking) or the like. In the usual case, the user would need to enter the “ALARM” mode to view the time that was earlier set. Regardless of the number of alarms possible in the prior art, most of the devices invariably have a limited number of settings. Even further is the fact that the user, in such known watches, cannot readily see at a single glance, the multiple meetings/appointments/alerts that have been set, since viewing them would typically require at best, sequencing through an “alarm” type mode, thereby further detracting from the user friendliness of the device. Still further is the fact that the prior art does not permit the storing or viewing of the duration of the period of time set for the meeting/appointment and/or activity/alert, since again at best, the prior art merely provides for the entering, storing and glancing of a meeting/appointment, activity and/or alert starting time, and not both the starting and ending time.

In those watches typically referred to as “analog” watches (e.g. whereby time is usually indicated by hour and minute hands), advancements have been made in being able to more easily store and/or view multiple alarms, the best of which is described in U.S. patent application Ser. No. 10/894,901.

In a similar manner, it is desired to provide further advancements for setting and displaying multiple meeting/appointments, activities and/or alerts without the need for an indicator hand.

### SUMMARY AND OBJECTIVES OF THE INVENTION

It is thus an objective of the present invention to overcome the perceived deficiencies in the prior art.

Specifically, it is an objective of the present invention to provide a method of and device for setting and indicating a plurality of meetings/appointments, activities and/or alerts using technology such as LCDs, EL and LEDs.

Moreover, it is an object of the present invention to provide such improvements in a multimode electronic device, such as but not limited to, a wristwatch, although as will become clear below, the electronic device need not be limited to a watch.

Yet a further object of the present invention is to provide a device that provides for a quicker and easier way to view multiple meetings/appointments and/or alert settings.

Still a further object of the present invention is to provide the user with the capability to see the duration of the period of time set for such a meeting/appointment and/or activity/alert.

Further objects and advantages of this invention will become more apparent from a consideration of the drawings and ensuing description.

The invention accordingly comprises the features of construction, combination of elements, arrangement of parts and sequence of steps which will be exemplified in the construction, illustration and description hereinafter set forth, and the scope of the invention will be indicated in the claims.

To overcome the perceived deficiencies in the prior art and to achieve the objects and advantages set forth above and below, the present invention is, generally speaking, directed to an electronic device comprising a plurality of liquid crystal display segments arranged circumferentially about the face, wherein each of the liquid crystal display segments represents a period of time that is based on the total number of arranged liquid crystal display segments, wherein each of the plurality of liquid crystal display segments are changeable between an inactive state and an active state; activation means for changing selected ones of the liquid crystal display segments between the inactive state and the active state by generating voltages across the selected ones of the liquid crystal display segments; and manual selecting means for selecting one or more of the liquid crystal display segments to change between one of the inactive state and active state to the other of the inactive state or active state.

In another embodiment, the electronic device comprises means for receiving signals from an external device, processing said signals and based thereon, selecting one or more of the liquid crystal display segments to change between one of the inactive state and active state to the other of the inactive state or active state.

In an alternative embodiment, the electronic device comprises an at least partially light transparent dial, the dial having a dial side and an opposing side; and a plurality of light emitting diodes arranged circumferentially about the dial and on the opposing side of the dial, wherein each of the light emitting diodes represents a period of time that is based on the total number of arranged light emitting diodes, wherein each of the plurality of light emitting diodes are changeable between a first state and a second state; activation means for changing selected ones of the light emitting diodes between the first state and the second state by applying voltages to the selected ones of the light emitting diodes; and means for at least one of (i) manually selecting one or more of the light emitting diodes to change between the first state and the second state and (ii) receiving signals from an external device, processing said signals and based thereon, selecting one or more of the light emitting diodes to change between the first state and the second state. Still further, this latter embodiment may comprise a plurality of liquid crystal display segments arranged circumferentially about a face of the electronic device, each of which is respectively aligned with one of the plurality of light emitting diodes, wherein each of the plurality of liquid crystal display segments are changeable between an inactive state and an active state; means for changing selected ones of the liquid crystal display segments between the inactive state and the active state by generating voltages across the selected ones of the liquid crystal display segments; and means for selecting one or more of the liquid crystal display segments to change between the inactive state and the active state; wherein when a light emitting diode is illuminated, the light from the illuminated light emitting diode is visible through the activated portion of the selected liquid crystal display segment.

In a specific embodiment, the electronic device disclosed herein is preferably a timepiece.

### BRIEF DESCRIPTION OF THE DRAWINGS

For a fuller understanding of the invention, reference is had to the following description taken in connection with the accompanying figures, in which:

FIG. 1 is an exploded view of a multimode electronic device constructed in accordance with the present invention;

FIG. 2 illustrates the multimode electronic device of FIG. 1, and in particular, the features and construction of a liquid crystal display of the present invention;

FIG. 3 is a block diagram of the multimode electronic device illustrated in FIGS. 1 and 2, generally depicting the plurality of electrical connections and driving means associated with the liquid crystal display of the present invention; and

FIG. 4 is a simplified exploded view of a multimode electronic device constructed in accordance with an alternative embodiment of the present invention.

Identical reference numerals in the figures are intended to indicate like parts, although not every feature in every figure may be called out with a reference numeral.

### DETAILED DESCRIPTION OF THE PREFERRED EMBODIMENTS

The present invention is directed to a device that provides for unique meetings/appointments and/or alert setting and/or viewing functionality in a multimode electronic device, such as a wristwatch. However, it should be understood that the present invention need not be a wristwatch, for the reasons that if not already clear, will become clear below. That is, other devices are very much contemplated hereby, and thus covered by the present claims. Reference should be made to co-owned and co-pending application Ser. No. 10/441,417, the disclosure of which is incorporated by reference as if fully set forth herein, which makes it clear that the device of the present invention can be a heartrate monitor and/or a compass, just to name a few.

Moreover, although the preferred embodiment will be disclosed with respect to the use of liquid crystal display technology, other technologies such as LEDs, EL and OLEDs may be implemented to take advantage of the invention disclosed herein. Reference to specifics as it relates to these alternative technologies is disclosed below.

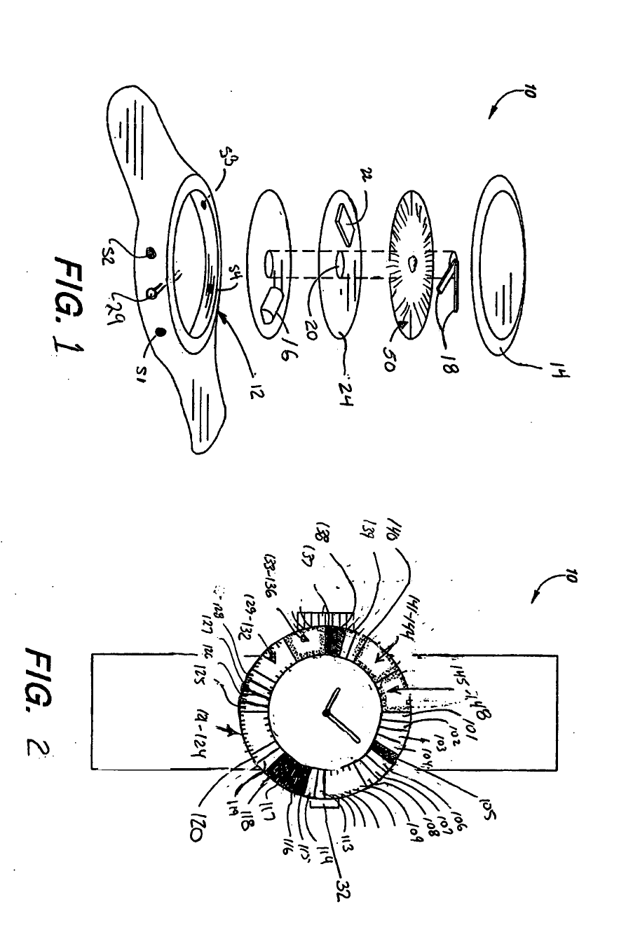

Turning to the preferred embodiment, FIG. 1 illustrates a multimode electronic device, generally indicated at 10, constructed in accordance with the present invention. Device 10, which in the preferred embodiment is a wristwatch, comprises a watch case 12, a watch crystal 14, timekeeping control electronics 16 which control the analog movement of conventional mechanical timekeeping hands 18 as is well known in the art. Mechanical hands 18 will be attached to a movement, which in the preferred embodiment is a stepping motor, through a seal-protected hole 20 in a liquid crystal display, generally indicated at 50 and constructed in accordance with the present invention. The ability to provide hands through a liquid crystal display is well known in the art.

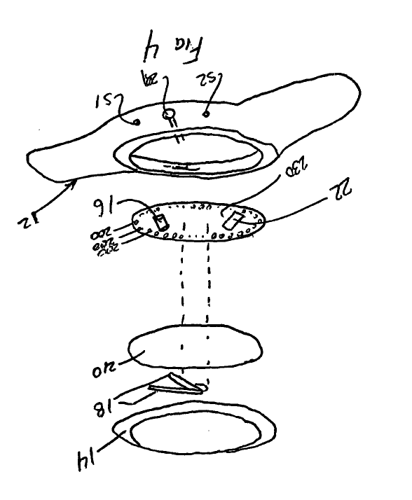

The electronics to control liquid crystal display 50 to change selected ones of the liquid crystal display segments between the inactive state and the active state by generating voltages across the selected ones of the liquid crystal display segments comprises a microprocessor 22 disposed on a printed circuit board 24 and dimensioned to be placed below liquid crystal display 50 and in electrical connection therewith. A common power source such as a battery 26 (FIG. 3) is used for both the timekeeping function (i.e. hand movement) and for powering the microprocessor 22 to power liquid crystal display 50.

Liquid crystal display 50 is preferably a multisegmented liquid crystal display, and the technology for constructing such displays is well known in the art, and the reader is invited to review U.S. Pat. No. 5,636,185 (and the references cited therein), the disclosure of which is hereby incorporated by reference as if fully set forth herein, for a description of a multisegmented liquid crystal display which is applicable for use in the present invention.

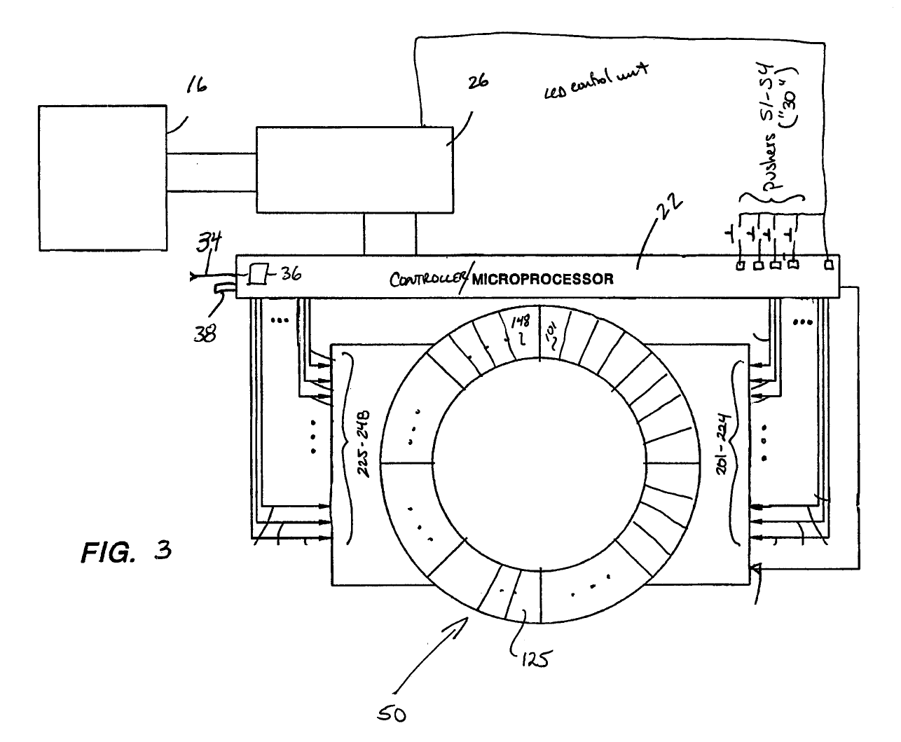

Reference is now made to FIG. 2, which illustrates device 10 generally, and liquid crystal display 50 in particular. Specifically, in the preferred embodiment, liquid crystal display 50 includes forty-eight (48) liquid crystal display segments 101-148 positioned along the outer periphery of (e.g. circumferentially about) liquid crystal display 50. By providing forty-eight (48) such segments, periods of time in increments of fifteen (15) minutes can be represented. In the illustrated embodiment, a period of time is represented by activating the appropriate liquid crystal display segment(s) (e.g. in an “on” state) while maintaining the immediately adjacent liquid crystal display segments in an “of” state.

If the liquid crystal display segments are those of the conventional twisted-neumatic (TN) type, it is well known that depending on the voltage placed across the LCD segment, the area may appear dark (i.e. black) or lighter (e.g. gray), thus that in the two states, the appearance of the LCD segment is visually different.

On the other hand, more recently developed technology, such as that described in U.S. Pat. No. 5,636,185, permits the LCD segments to be displayed in contrasting colors. For example, in an “active” state, a display segment may be displayed in a first color (e.g. red), while in an “inactive” state, the same display segment may appear as a second color (e.g. “yellow”). In this way as well, selecting one or more segments to appear in the first color (e.g. red) will, in accordance with the present invention, represent a period of time extending for the number of segments in the “red” color (e.g. the “yellow” segments adjacent the “red” block will border the beginning and end times, as further explained below).

The exact number of liquid crystal display segments along the outer periphery is one of design choice. For example, sixty (60) such segments may be appropriate for individuals who have more non-typical meeting/activity/activity schedules and/or who desire more specific alert settings. Similarly, the outer periphery may be limited to twelve (12) display segments where the exact minute is not of particular importance.

By way of general background into the operation of the present invention, reference is made to FIG. 3, which is a block diagram generally representing the plurality of electrical connections and the activation means associated with liquid crystal display 50. In the illustrated embodiment, each of the preferred forty-eight (48) liquid crystal display segments 101-148 is individually connected to controller/microprocessor 22 by respective electrical connections 201-248. Input commands or signals to controller/microprocessor 22 for selecting one or more of the liquid crystal display segments to change between one of the inactive state and active state to the other of the inactive state or active state originate from a manual selecting means, which may comprise one or more top and/or side pushers, illustrated generically as 30, and/or a setting stem 32. Technology regarding use of one or more pushers is extremely well known in the art, and use of a setting stem for functions other than mere pushing to make an electrical connection, can be well understood by a reading of U.S. Patent Application Serial No. 10/331,827 for example, the disclosure of which is incorporated by reference as if fully set forth herein.

The plurality of electrode segments on the upper substrate and the common electrode segment (not shown) on the lower substrate of liquid crystal display 50 are selectively activated by controller/microprocessor 22 to establish electric fields of varying magnitudes which effectuates changes in each liquid crystal display segment between an inactive state and an active state (or between an active state and an inactive state). With color dyes, each liquid crystal display segments produces a first color when the liquid crystal display segment is placed in the inactive state and a second color when the liquid crystal display segments are placed in the active state. Likewise, control over the gray/clear/dark appearance in a conventional twisted neumatic liquid crystal display can be appropriately maintained by applying the appropriate voltages across the electrodes. Controller/microprocessor 22 preferably has a built in liquid crystal driving mechanism, known in the art, to drive the selected liquid crystal display segments in accordance with their construction.

Exemplary Scales

1. 6:00 am to 6:00 pm Scale

In a purely exemplary embodiment, which is depicted in FIG. 2, it can be seen that meetings/appointments have been set for 9:00 a.m. to 9:30 a.m., 1:00 p.m. to 1:15 p.m. and 3:30 p.m. to 4:30 p.m.

2. Twenty Four Hour Scale

In an alternative embodiment, additional (e.g. thinner) segments may be provided and/or the scale can be slightly reconfigured so that the summation of all the segments represents a block of time equal to 24 hours. In the case where the scale of FIG. 2 is deemed to represent a twenty-four (24) hour period, each segment may represent a period of time equal to 30 minutes.

The user interface to select (and/or traverse (i.e. skip)) one or more of the liquid crystal display segments is as follows:

Once a “scheduling” mode has been entered, such as by actuation of a selected pusher or axial compression or pulling of the setting stem 29, the device will be receptive and responsive to actuations of another of the (or the same) pushers and/or setting stem, for selecting the one or more liquid crystal display segments to change between an inactive state and an active state. For example, pressing a particular pusher (e.g. S1) or pulling (or pushing) the setting stem to be axially displaced from one position to another, would cause the device to enter the “scheduler” mode. Beginning at a predetermined liquid crystal display segment, which may be indicated by flashing or blinking, subsequent liquid crystal display segments can then be traversed (i.e. skipped) until the desired liquid crystal display segment(s) is selected.

Importantly, it is desirable to ensure that the user can ascertain the position of the “cursor” (i.e. which segment is being “accessed” at that moment) and the status (e.g. free to set or already set (i.e. busy)) of that particular segment when the “cursor” is upon it (i.e. status of segment being “accessed”). For this reason, each segment preferably has at least four (4) visual states; namely (i) “static of” wherein the “cursor” is not on the segment and the corresponding time period is “free”; (ii) “static on” wherein the “cursor” is not on the segment and the corresponding time period is busy; (iii) the segment is flashing, for example, at a 33% duty cycle corresponding to a “cursor” that is on the segment and the corresponding time period is free; and (iv) the segment is flashing, for example, at a 67% duty cycle corresponding to a “cursor” that is on the segment and the corresponding time period is busy. These visual states are exemplified below.

For example, upon entering the scheduler mode, liquid crystal display segment 125 will begin to flash (thus, consistent with the foregoing, the “cursor” would be on segment 125). It is to be noted that beginning at this segment 125 is for mere convenience as it represents the 6:00 a.m. hour in the preferred configuration. Clearly, other starting points about the face of the device are contemplated herein. Repeated (or continuous) actuation of a pusher (e.g. S2) will cause the “cursor” to move about in a clockwise manner, such that consecutive liquid crystal display segments, beginning with segment 126, will flash. It should thus be understood that each successive segment “accessed” between segment 125 and 136, the corresponding segment will, in this example, flash at the aforementioned 33% duty cycle when the “cursor” is upon it. Upon the reaching of liquid crystal display segment 137 representing the period of time between 9:00 a.m. and 9:15 a.m., the user will press a pusher (e.g. S3), thereby selecting liquid crystal display segment 137 and causing it to change from inactive (or active) to active (or inactive) in order for there to be a visible marker at this 9:00 a.m. position. Segment 137, in that it is currently the segment being accessed (and now switched to “busy”), will begin to flash at the 67% duty cycle. Thereafter, actuation of pusher S2 will cause the “cursor” to move to liquid crystal display segment 138, which will then begin to flash at the 33% duty cycle (because it has yet to be changed from “free” to “busy”). Actuation of pusher S3, in this example, will cause segment 138 changes to its “opposite” state to indicate that it is now “busy.”

Continuing with the above example, repeated (or continuous) actuation of pusher S2 will cause in a clockwise manner, consecutive liquid crystal display segments, beginning with segment 139, to flash at the 33% duty cycle. Upon the reaching of liquid crystal display segment 105 representing the period of time between 1:00 p.m. and 1:15 p.m., the user will see that it is flashing at the 33% duty cycle, and pressing pusher S3 will select liquid crystal display segment 105 and cause it to change from inactive (or active) to active (or inactive) in order for there to be a visible marker at this 1:00 p.m. position.

The foregoing sequence can be followed to select consecutive liquid crystal display segments 115-118 to select the block of time between 3:30 p.m. and 4:30 p.m. To be clear, if the user were again to sequence around the segments, for example, pausing of the “cursor” upon a “busy” segment (e.g. segments 137, 138) the user will see it flashing at the 67% duty cycle.

Clearly, certain variations are well within the skill of the ordinary artisan. For example, any of the segments may be selected by default (i.e. non-actuation of any pusher for a certain duration (e.g. 3 seconds)). Similarly, less than three (3) pushers may be utilized to achieve all of the foregoing. Also, the rate of flashing can be modified or changed if desired. As indicated above, the selection of the desired liquid crystal display segments (e.g. segments 137, 138) can also be achieved by use of a setting stem. For example, while S1 may still be used to enter the “scheduler” mode, under a particularized configuration, clockwise or counterclockwise rotation of the setting stem can provide for traversing of the non-desired segments, while on the other hand, once a desired segment is reached (e.g. segment 115), selection thereof may be achieved by one or more of the following: (i) compression (i.e. pushing) of the setting stem, (ii) delay by no further rotation thereof, and/or (iii) a selected pusher. In this way, the user can likewise quickly select the starting time and/or the ending time of the meeting/appointment and select consecutive liquid crystal display segments that denote a starting time prior to the selected segment, or an ending time thereafter. That is, in this embodiment, use of pushers or the setting stem provides for selection of segment 118 and then proceeds to provide for the changing of segments 117, 116 and 115 (consecutively) from their respective inactive to active (or active to inactive) states.

It is important to note that the present invention contemplates both active to inactive and inactive to active state changes since the liquid crystal display technology of the preferred embodiment provides for changing color, shades and/or light transmissibility under various configurations, and therefore, the invention is not limited to only one configuration.

In another embodiment, the present invention provides for receiving signals from an external device, processing the signals and based thereon, selecting one or more of the liquid crystal display segments to change between one of the inactive state and active state to the other of the inactive state or active state. Accordingly, controller/microprocessor 22 may comprise an antenna 34 and receiver 36 for receiving wirelessly transmitted signals and/or a port 38 for receiving wired signals (e.g. USB). In this way, meetings/appointments or other activities and/or alerts can be programmed into and displayed on the device from an external source. This feature is particularly advantageous when a user wishes to download appointments/meetings, activities and/or alerts that are already stored in a separate computer (e.g. PDA, PC and/or laptop, etc.). Here preferably, all the selected liquid crystal display segments can be “highlighted” together.

“Deselection” of one or more liquid crystal display segments can be achieved by similar means, such as having a designated pusher that “deselects” the segment(s) that may have previously been selected.

As another feature, if controller/microprocessor 22 is maintaining the time of day, an audible (e.g. buzzer), visual (e.g. LED) or tactile (e.g. vibrator) alert can be provided when the beginning time of the selected schedule meeting/appointment, activity and/or alert has occurred. For example, in such an embodiment, the controller/microprocessor would maintain the time-of-day, a feature well-known in the art (such as it does in a digital and/or “combo” (i.e. analog and digital timepiece)). Thereafter, controller/microprocessor 22 would also be programmed to maintain information regarding the time periods to which each of the segments or LEDs (as set forth below) correspond (it is even contemplated that the time of day could be set using only the segments or LEDs). In this way, an alert can be provided when the time of day coincides with the time corresponding to the next “busy” segment (or LED).

While the invention has been particularly shown and described with respect to preferred embodiments thereof, it will be understood by those skilled in the art that changes in form and details may be made therein without departing from the scope and spirit of the invention.

For example, the present invention can be achieved by using EL, LED and/or OLED technology by providing multiple LEDs or the like along the periphery of the face of a dial (in this case, it would not be a liquid crystal display but rather a conventional dial). Such LEDs could be placed above the dial or below it. Similarly, the use of separate and/or multiple EL panels could be provided to illuminate selected segments using electroluminescent technology. A simplified embodiment using LEDs or OLEDs is illustrated in FIG. 4, wherein a plurality (e.g. 48) of LEDs, all of which are individually designated by reference number 200, are arranged around the periphery of a board 230. In the embodiment of FIG. 4, the LEDs are arranged below dial 210 and are individually illuminable under the control of microprocessor 22, which is exemplary positioned on board 230. To be clear, the LEDs could be placed above the dial on a separate board or coupled to the dial itself if desired (or practical). The circuitry for using LEDs in place of the aforementioned LCD segments to carry out the aforementioned methodology should be understood by one skilled in the art.

In this way, FIG. 4 fully discloses an electronic device comprising an at least partially light transparent dial 210, the dial having a dial side and an opposing side; a plurality of light emitting diodes 200 arranged circumferentially about the dial 210 and on the opposing side of the dial, wherein each of the light emitting diodes 200 represents a period of time that is based on the total number of arranged light emitting diodes, wherein each of the plurality of light emitting diodes are changeable between a first state (e.g. not illuminated) and a second state (e.g. illuminated); activation means, such as controller 22 for changing selected ones of the light emitting diodes between the first state and the second state by applying voltages to the selected ones of the light emitting diodes; and means (such as pushers and/or the setting stem, on the one hand, or components such as a receiver and antenna on the other) for at least one of (i) manually selecting one or more of the light emitting diodes to change between the first state and the second state and (ii) receiving signals from an external device, processing said signals and based thereon, selecting one or more of the light emitting diodes to change between the first state and the second state.

Again, if liquid crystal display segments are used in such a configuration, the plurality of liquid crystal display segments 205 would be arranged circumferentially about the face of the electronic device (i.e. about display 206 or 50), each of which would be respectively aligned with one of the plurality of light emitting diodes, wherein each of the plurality of liquid crystal display segments are changeable between an inactive state and an active state. Controller 22 provides for changing selected ones of the liquid crystal display segments between the inactive state and the active state by generating voltages across the selected ones of the liquid crystal display segments; and the aforementioned means (pushers, setting stem and/or a receiver 36) is provided for selecting one or more of the liquid crystal display segments to change between the inactive state and the active state; wherein when a light emitting diode is illuminated, the light from the illuminated light emitting diode is visible through the activated portion of the selected liquid crystal display segment such as that disclosed in copending application Ser. No. 10/894,901. In this embodiment, the light emitting diodes are not visible through the at least partially light transparent dial when the light emitting diode is not illuminated and the liquid crystal display segment is not in its active state.

In a similar manner, use of EL segments can be utilized, and the embodiment of FIGS. 1-3 should be deemed to adequately disclose an embodiment wherein EL segment are used in place of LCD segments.

It can thus be seen that the present invention provides for significant advancements over the prior art, including providing constructions for setting and indicating a plurality of meetings/appointments, activities and/or alerts using technology such as LCDs, EL and LEDs. Moreover, the present invention provides constructions and methodologies for more quickly and easily viewing multiple meetings/appointments and/or alert settings on the face of the device. Still further, the present invention provides the capability to see the duration of the period of time set for such a meeting/appointment and/or activity/alert, which is absent in similar devices. Lastly, in yet another feature, especially if battery consumption was a concern for example, the LEDs or other display segments may not be showing the set appointments/alerts until such display was requested, by such as a designated pusher or the like. In this way, the display of the set meetings/appointments can be “on-demand”, thereby conserving battery power. Also, to be sure, the features and advantages of the first-mentioned embodiment herein are equally applicable to the embodiment utilizing LEDs. As but only one example, the LEDs will similarly flash at the aforementioned duty cycles to indicate where the “cursor” is located and the status of the specific LED.

What is claimed is:

1. An electronic device having a face, the electronic device comprising:
a plurality of liquid crystal display segments arranged circumferentially about the face, wherein each of the liquid crystal display segments represents a period of time that is based on the total number of arranged liquid crystal display segments, wherein each of the plurality of liquid crystal display segments are changeable between an inactive state and an active state;
activation means for changing selected ones of the liquid crystal display segments between the inactive state and the active state by generating voltages across the selected ones of the liquid crystal display segments; and
manual selecting means for selecting one or more of the liquid crystal display segments to change between one of the inactive state and active state to the other of the inactive state or active state.

2. The electronic device as claimed in claim 1, wherein the position of each of the liquid crystal display segments represents a beginning time and an ending time of the period of time.

3. The electronic device as claimed in claim 1, wherein more than one consecutive liquid crystal display segment is manually selectable, wherein the changing of the consecutive liquid crystal display segments between one of the inactive state and active state to the other of the inactive state or active states represents a block of time; and
wherein the position of the first of the consecutive liquid crystal display segments represents a beginning time of the block of time and the position of the last one of the consecutive liquid crystal display segments represents an ending time of the block of time.

4. The electronic device as claimed in claim 1, wherein the selecting means includes means for traversing one or more of the liquid display segments until a desired liquid crystal display segment is selected for changing from one of the inactive or active state to the other of the inactive or active state.

5. The electronic device as claimed in claim 4, wherein more than one consecutive liquid crystal display segment is manually selectable, wherein the changing of the consecutive liquid crystal display segments between one of the inactive state and active state to the other of the inactive state or active states represents a block of time; and
wherein the position of the first of the consecutive liquid crystal display segments represents a beginning time of the block of time and the position of the last one of the consecutive liquid crystal display segments represents an ending time of the block of time; and
wherein the desired liquid display segment is either the first or last of the consecutive liquid display segments.

6. The electronic device as claimed in claim 1, wherein a plurality of non-consecutive liquid crystal display segments can be selectively changed from their respective active or inactive state to the other of the active or inactive state.

7. The electronic device as claimed in claim 1, wherein the manual selecting means comprises one or more pushers and/or a setting stem, wherein actuation of the manual selecting means causes actuation of consecutive liquid crystal display segments from their respective active or inactive state to the other of the active or inactive state.

8. The electronic device as claimed in claim 7, wherein selective actuation of the manual selecting means causes the changing back of the liquid crystal display segments from their current inactive or active state to their previous inactive or active state.

9. The electronic device as claimed in claim 1, wherein the device comprises forty-eight (48) liquid crystal display segments arranged circumferentially about the face;
wherein the activation of each of the liquid crystal display segments represents a period of time of 15 minutes.

10. The electronic device as claimed in claim 1, wherein the electronic device is a timepiece.

11. The electronic device as claimed in claim 1, including alerting means for providing an alert at a time corresponding to a liquid crystal display segment that has been selected.

12. The electronic device as claimed in claim 1, including alerting means for providing an alert when a time of day corresponds to a liquid crystal display segment that has changed from the inactive state to the active state.

13. An electronic device having a face, the electronic device comprising:
a plurality of liquid crystal display segments arranged circumferentially about the face, wherein each of the liquid crystal display segments represents a period of time that is based on the total number of arranged liquid crystal display segments, wherein each of the plurality of liquid crystal display segments are changeable between an inactive state and an active state;
activation means for changing selected ones of the liquid crystal display segments between the inactive state and the active state by generating voltages across the selected ones of the liquid crystal display segments; and
means for receiving signals from an external device, processing said signals and based thereon, selecting one or more of the liquid crystal display segments to change between one of the inactive state and active state to the other of the inactive state or active state.

14. The electronic device as claimed in claim 13, wherein the activation means at least essentially simultaneously changes the selected liquid crystal display segments from one of the inactive and active states to the other of the inactive or active states.

15. An electronic device comprising:
an at least partially light transparent dial, the dial having a dial side and an opposing side;
a plurality of light emitting diodes arranged circumferentially about the dial, wherein each of the light emitting diodes represents a period of time that is based on the total number of arranged light emitting diodes, wherein each of the plurality of light emitting diodes are changeable between a first state and a second state;
activation means for changing selected ones of the light emitting diodes between the first state and the second state by applying voltages to the selected ones of the light emitting diodes; and
means for at least one of (i) manually selecting one or more of the light emitting diodes to change between the first state and the second state and (ii) receiving signals from an external device, processing said signals and based thereon, selecting one or more of the light emitting diodes to change between the first state and the second state.

16. The electronic device as claimed in claim 15, wherein the plurality of light emitting diodes are positioned on the opposing side of the dial.

17. The electronic device as claimed in claim 16, wherein in the first state the light emitting diode is in a non-illuminated state and wherein in the second state the light emitting diode is in an illuminated state; and
wherein the light emitting diodes are not visible through the at least partially light transparent dial when the light emitting diode is not illuminated and the liquid crystal display segment is not in its active state.

18. An electronic device comprising:
an at least partially light transparent dial, the dial having a dial side and an actuation mechanism side;
a plurality of illuminable display segments arranged circumferentially about the dial, wherein each of the illuminable display segments represent a period of time that is based on the total number of arranged illuminable display segments, wherein each of the plurality of illuminable display segments are changeable between a first state and a second state;
activation means for changing selected ones of the illuminable display segments between the first state and the second state by applying voltages to the selected ones of the illuminable display segments; and
means for at least one of (i) manually selecting one or more of the illuminable display segments to change between the first state and the second state and (ii) receiving signals from an external device, processing said signals and based thereon, selecting one or more of the illuminable display segments to change between the first state and the second state.
